(19) United States
(12) Patent Application Publication
(10) Pub. No.: US 2013/0090980 A1
(43) Pub. Date: Apr. 11, 2013

(54) SYSTEM & METHOD FOR TRACKING MEMBERS OF AN AFFINITY GROUP

(71) Applicant: Brett Patrick Hummel, Newtown Square, PA (US)

(72) Inventor: Brett Patrick Hummel, Newtown Square, PA (US)

(21) Appl. No.: 13/647,702

(22) Filed: Oct. 9, 2012

Related U.S. Application Data
(60) Provisional application No. 61/545,380, filed on Oct. 10, 2011.

(51) Int. Cl. G06Q 30/02

(52) U.S. Cl. 705/7.29

(57) ABSTRACT

A system and method for affinity groups to enable peer-to-peer engagement, raise the relationship state of their membership and increase the probability of members making a purchase combined with a vehicle to accept a payment for a purchase. The system and method also allows an affinity group to capture and solicit a member while he/she is in a higher state before, at or subsequent to an engagement activity. The system and method include a central server or group of servers that the affinity group operates. The server includes software that enables the management of an electronic network of both peer-to-peer interaction and central-based interactions. The system and method uses data collected about the members, including historical data of previous affinity group activities and events to make predictions on when and what to offer members the opportunity to make purchases or donations related to the affinity group. Such offers are referred to as “Asks”. The system and method also provide for creating meetups for members, both planned and impromptu.

### CROSS-REFERENCE TO RELATED APPLICATIONS

This utility application claims the benefit under 35 U.S.C. §119(e) of Provisional Application Ser. No. 61/545,380 filed on Oct. 10, 2011 entitled METHOD FOR TRACKING MEMBERS OF AN AFFINITY GROUP and whose entire disclosure is incorporated by reference herein.

### BACKGROUND OF THE INVENTION

1. Field of Invention

This invention relates to the field tracking individuals and, in particular, to tracking individual members of an affinity group.

2. Description of Related Art

In our society, people join groups to receive benefits such as feeling apart of a community, to get a sense of belonging, networking, etc. Usually these groups (affinity groups) are organized around a common cause, interest or affinity. As affinity groups mature, many develop into centralized institutions that govern the behavior of the group, its relationship with its members and enable them to solicit funds from their members in order to continue operations. In return for the funding, the organizations provide social benefits, goods, services, government policies and charity to its membership base. There are a wide variety of affinity groups ranging from corporations/firms to universities, musical bands, entertainers, concerts, non-profits, politicians and political campaigns. The supporters, customers or fan base (all of which will henceforth also be known as people, users, customers, consumers or members) of these affinity groups become the entity's membership base who are potentially willing to monetarily support the affinity group so it can survive.

Customers exist in various relationship states within their affinity group. A member can move between the different states (the number of relationship states for each affinity group varies widely). These states range from dormant/low engagement (the person interacts with the group or its members at a lower frequency than the average member and/or buys/gives at a low frequency and small amount) to high states where the member has many engagements or actively/routinely purchases from or donates to the group on a regular basis. Members are in the highest engagement state when they are willing to make a purchase from the affinity group, and customers in these higher states have the greatest likelihood of transferring into the highest state. Consumers in the highest state may only exist in the highest state for only a few moments, so it is critical that an affinity is able to solicit funds whenever and wherever the member is in the highest state.

A person's relationship with an entity or the set of discrete encounters the members have with the affinity affects their engagement state. In order to change states (either up or down) these affinity-member interactions must cross a threshold for each state, which individual members set for themselves. Members also have the ability to jump one or more states depending on the magnitude of the interaction between the group and individual. As the customer transitions between different levels and crosses various thresholds from encounters with the affinity group, they become more or less likely to purchase goods or services from the affinity group and/or donate to the affinity group's cause. Transitioning a customer from a ‘low’ consumption/donation state to a high state is the goal of many organizations.

How these organizations accomplish this task is as varied as the industries/organizations they represent, with airline companies developing frequent flier programs, universities creating reunions for alumni, non-profits hosting galas and politicians organizing fundraising dinners/rallies. Each affinity group attempts to make as many positive touch points and customer engagement events as possible to influence the member's state in a positive direction if they are in a low state and sustain members who are in a high state for an extended period of time. Customer Relationship Management (CRM) has focused on developing models for these consumer behaviors. However, CRM has usually focused on latent class models (Kamakura & Russell '98), which are static and do not take into account the effects of a consumer's constantly changing environment. Only until recently has CRM research begun to add more dynamic movement where individuals can transition between the latent states using Hidden Markov Models (HMM).

With Markov models and time varying co-variants, these models do a better job of predicting when people will transition between states and make a purchase or donation than previous CRMs. However, the models depend on the affinity group organizing the interactions between members. See FIG. 1. In these models, the affinity group provides or is the catalyst for the interactions between a customer and the affinity group. For the purposes of this disclosure this engagement technique can be known as the centrally organized or central based engagement system. The centrally organized encounters between group and member such as purchases of goods/services, exposure to advertising or marketing, promotions and service calls originate from one source (the affinity group) out to an individual (the customer), resulting in a one-to-one relationship.

After the introduction of an encounter to a customer's environment, feedback, information, purchases, etc., can flow back and forth between the two parties in this one-to-one manner. Even for relationship engagements where multiple members are present such as a campaign rally, product launch event or television advertising, the central creator (the affinity group) is trying to reach and influence the decisions of each individual that together form the whole of their membership. From these ‘group’ messages and meetings, each individual takes only the specific part of the advertising, message and/or encounter that influences their current engagement state and discards the part of the message that is not relevant. Without the affinity group, the relationship between both parties ceases to exist, i.e. the affinity group is the source of the relationship. In particular, as shown most clearly in FIG. 1, an affinity group 1 produces content, promotions, loyalty programs, events, advertisements and customer purchases/donations. The affinity group 1 creates almost all interactions and engagements between the members 1A, 1B, 1C, etc. and the group 1. It should be noted that the connections 2 between the members 1A, 1B, 1C, etc., is weak. The affinity group 1 is the central organizer of all events. Even when the affinity group 1 is reaching multiple people at the same time, it has an individual relationship with each member, and every member is then influenced by the part of the encounter that changes their engagement state, e.g., higher or lower.

Affinity groups create various time-based co-variants (loyalty clubs, reunions, advertising, service encounters, etc.) that establish the relationship between the customer and the organization as well as affect the current relationship state of the customer. As a customer interacts with these co-variants, each relationship encounter becomes part of a history of such interactions and forms the basis of the member's current state. This history influences the next meeting between the parties with the most recent encounters having the greatest influence on a person's current state. The influence of each encounter is determined by the total number of encounters, magnitude of an encounter, time between encounters and time decay (over time past event have less and less influence). To counter the time decay phenomenon, the dynamic HMMs demonstrate that the use of intermittent reinforcement theory, which states that increasing interactions between customer and affinity group has a positive correlation with raising a person's state and decision to purchase, helps replace events with decaying influence with fresh interactions and works especially well in moving people from a dormant/low sate to a higher state.

Another method to keep a person sustained in a higher state is through the act of purchasing or donating. Studies show when a positive choice (the person decides to give a donation for example) is made, the person begins a gifting habit whereby they are more likely to give/purchase in the future. The greater the number of payments or donations made, the more entrenched this gifting habit becomes. This holds true regardless of the size of the transaction.

The central engagement system and gifting habit are mutually reinforcing phenomenon. The chance that a member moves to a higher state is positively correlated with an affinity group increasing the number of interactions between entity and member. Once in this higher state, the person is more likely to purchase/donate, establishing the gifting habit. If an organization can keep the person in this high state, they can probably make another purchase, reinforcing the person's gifting habit and propensity to purchase/give in the future. Traditionally though the organization and members have limited interaction because as the central and sole generator of engagement, an entity must create, initially pay for, organize and support each interaction. The sheer cost of these activities is enormous on a personnel, logistical and monetary basis. As a result, many organizations cannot have continuous engagement (defined as frequent, impactful events that affect a customer's relationship with the entity) with people and must instead selectively pick and choose how to best engage them.

Thus, there remains a need for a system and method that can multiply the number of engagements that an affinity group can host while increasing its membership and interactions/encounters with its members. In addition, there remains a need for providing the affinity group with the ability to focus its limited resources and central engagement on more specific and high value targets where members may be in a high-engaged state, thereby more willing to make a purchase or a contribution and to stay in that high-engaged state for longer periods of time.

### BRIEF SUMMARY OF THE INVENTION

A system for at least one affinity group to expand its membership and engage its membership in more transactions and activities, and wherein the at least one affinity group includes a central organization and a plurality of members, is disclosed. The system comprises: user devices (e.g., cellphones, smartphones, computers, tablet, laptop or notebook computers, etc.) that can communicate over the Internet or telephone or data networks; wherein each of the user devices comprises software that is customized to the at least one affinity group policies and activities; and wherein each of the user devices is associated with a respective one of the plurality of members or with a respective one of a plurality of potential members of the at least one affinity group; wherein at least one server, associated with the at least one affinity group, is in communication with the user devices over the Internet, telephone or data networks; wherein the at least one server comprises software that configures the at least one server to manage peer-to-peer interaction and central-based interaction, as well as algorithms for analyzing end user-provided data and data associated with the at least one affinity group provided thereby; wherein at least one message gateway is positioned between the user devices and the at least one server, wherein the at least one message gateway provides a pathway for sending a message or content between the user devices and the at least one server; and wherein the plurality of members form peer-to-peer relationships with each other using the user devices with little or no involvement by the central organization.

A method for at least one affinity group to expand its membership and to engage its membership in more transactions and activities, wherein the at least one infinity group includes a central organization and a plurality of members, is disclosed. The method comprises: providing user devices (e.g., cellphones, smartphones, computers, tablet, laptop or notebook computers, etc.) that can communicate over the Internet or telephone or data networks, and wherein each of the user devices comprises software that is customized to the at least one affinity group policies and activities, and wherein each of the user devices is associated with a respective one of the plurality of members or with a respective one of a plurality of potential members of the at least one affinity group; configuring at least one server with software that manages peer-to-peer interactions and central-based interactions, as well as implements algorithms for analyzing end user-provided data and data associated with the at least one affinity group provided thereby; coupling the at least one server with the Internet, telephone or data networks to be in communication with the user devices, and wherein the coupling involves positioning at least one message gateway between the user devices and the at least one server, and wherein the at least one message gateway provides a pathway for sending a message or content between the user devices and the at least one server; and establishing peer-to-peer relationships among the plurality of users with little or no involvement by the central organization.

### BRIEF DESCRIPTION OF SEVERAL VIEWS OF THE DRAWINGS

The invention will be described in conjunction with the following drawings in which like reference numerals designate like elements and wherein:

FIG. 1 is a block diagram describing a prior art centrally-organized affinity group;

FIG. 2 is a block diagram of the peer-to-peer affinity group model of the present invention;

FIG. 3 is a block diagram describing a hybrid affinity group model of the present invention;

FIG. 4 is a functional diagram of the present invention showing the process of soliciting a group's membership base of an affinity group, generating an “Ask” and effecting a transaction, either a purchase or a donation, using the system and method of the present invention;

FIG. 5 is a functional diagram of a user moving to a higher engagement state;

FIG. 6 is a block diagram describing the functions of how a member registers for the affinity group;

FIG. 7 is a block diagram of a system and method of the present invention that depicts an implementation for matching members at an event, determining the solicitation to be Ask'd and obtaining the Ask;

FIG. 8 is a block diagram of a system and method of the present invention that depicts an implementation for matching members at an event and if it becomes a successful engagement, to match the group members with a second engagement and proactively alert them to the presence of this second event;

FIG. 9 is a block diagram of a method of tracking how members of an affinity group respond to various stimuli, comparing those sponsors to the affinity group's goals for an event and then providing additional stimuli at a secondary event to move a member towards the affinity group's goal for a second event; and

FIG. 10 is a block diagram of a system and method for combining data from a group of engagements and create a representation of how engaging a particular set of engagements were and how engaged a set of users are/were. Based on this constantly adjusting pulse, the system and method can select how engaging future events/engagements will be.

### DETAILED DESCRIPTION OF PREFERRED EMBODIMENTS OF THE INVENTION

### Definitions

Before a detailed description of the system and method of the present invention is discussed the following are definitions of terms and phrases as used throughout this Specification:

Affinity Group—An affinity group is one or more people who collectively support a cause, community, affinity, company, firm, politician, non-profit, person or group. Affinity groups typically but not always adopt a centralized structure that develops products, goods, services or benefits for their members to purchase or receive. It is through their member's support (financially especially) that the affinity groups can continue to function. Affinity groups can select leaders and/or staff. The leaders, staff, and any other members of the affinity group can execute the functions of the affinity group, including, but not limited to developing algorithms.

Ask—A solicitation of an affinity group's membership base from the affinity group. This solicitation can range from offers for goods/services to promotional deals or donation requests. The “Asks” may or may not contain content/media. An “Ask” has four parts. First, determining whether or not to make a solicitation request. Second, selecting the amount to solicit. Third, deciding when to make the “Ask”. The “Ask” can come to the member through a multitude of message gateways and may contain messages or statements to the member. The fourth and final aspect is the frequency. This set of variables determines how soon after a previous “Ask” to send another one.

Content/Media—Material in a graphical, digital, analogue or printed form that contains information. This content can range from videos to handwritten letters. Media can be streamed directly to a device, sent to a physical or email address, viewed through an internet connection or unlocked with a code/pin. Content can originate with the affinity group or from a third part not associated with the affinity in any way.

Device—A device is any tool that a person has to access to software programs that enable a person to connect with people, contact people, view the internet/world wide web, send messages back and forth with people and communicate with people. They may or may not connect to the internet or over a telecommunications infrastructure. Examples of devices are cell/mobile phones, landline phones, tablets, netbooks, desktop computers, cloud computers, web browsers and smartphones.

Engagement—An engagement is an encounter. Events are one type of engagement. If the encounter is central based, then it is an interaction between the affinity group and a customer. Examples include a customer service call, purchasing an item from the affinity group, a fundraising dinner for a charity and a political rally. If the encounter is peer-to-peer based, then the engagement is a meeting between two or more members of an affinity group. This meeting does not have to be in any way related to the affinity group either. One possible example is a person from the Audubon Society meeting someone who is also part of the society for coffee to talk about home repair.

Message Gateway—A message gateway is a pathway to send a message or content from a source, usually a server, to a device or member. This can include electronic/digital as well as non-electronic means. SMS text messages, phone calls, emails, handwritten letters, in app pop up notifications, web browser notifications, push notifications, instant messaging, messaging, posting a message on a blog, comments and any notification in general are all example of Message Gateways.

Purchase—A purchase is the act of a person obtaining a good, service or promotion (coupon, discount, code, deal, etc.) from another person, entity or affinity group. In this definition, a purchase also includes a person requesting content/media, as well as, a person donating to a cause, non-profit or affinity group. The purchase may or may not require the person obtaining the item, good, service, promotion or content/media to provide monetary compensation to receive the item(s) purchased.

User Type—A group of users who have similar characteristics. Each affinity group can define the characteristics and how their membership base fits into each User Type.

### DESCRIPTION

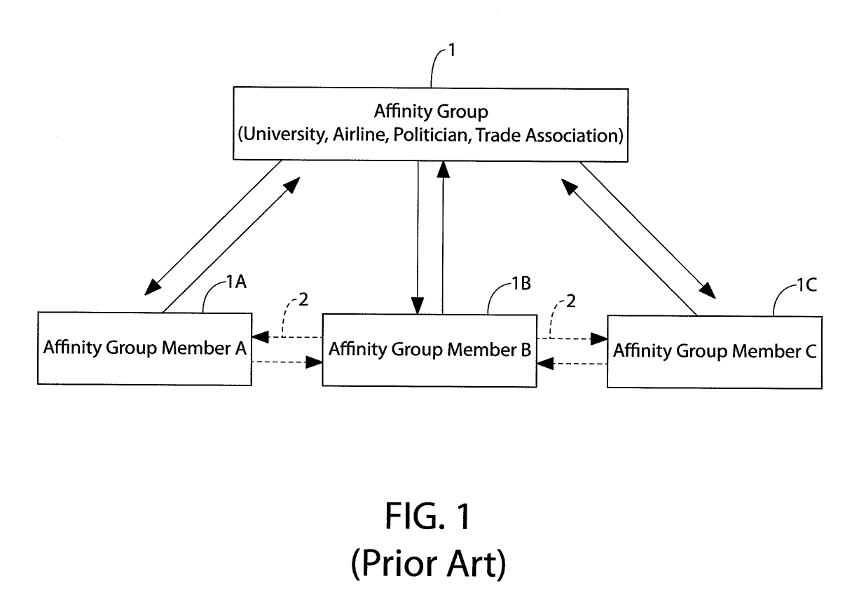

Taking advantage of new tools and technology, the present invention provides a new system and method for engaging an affinity group's customers. Instead of having the customer interact solely with the entity through the central engagement system (as shown in FIG. 1), a new distributed system and method is provided by the present invention. This system and method depends on peer-to-peer (customer-to-customer) interactions to substitute for the central approach while achieving the same benefits of the central system: a) engagement with the customer, b) transferring a member to a higher state and c) increasing the probability of the member making a purchase/donation.

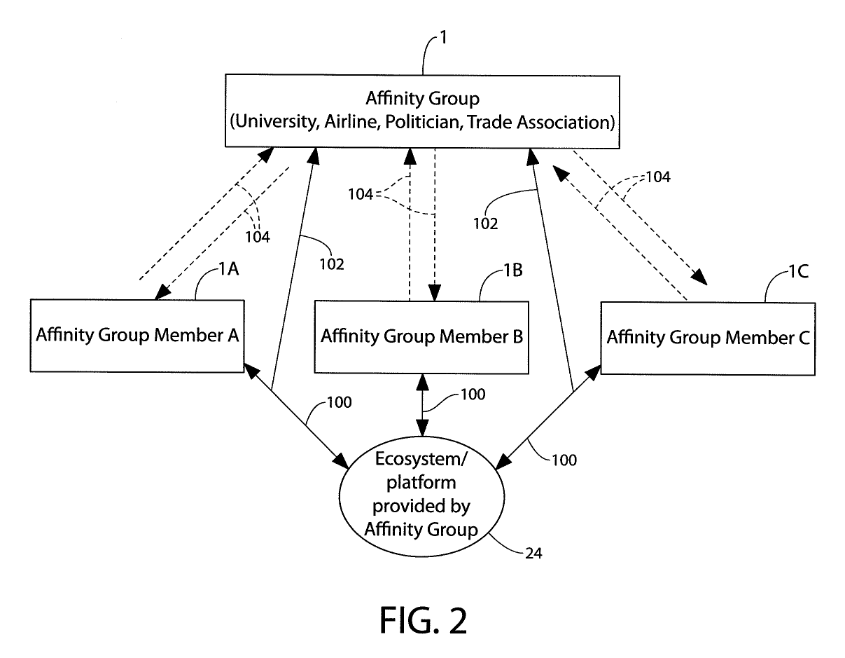

Peer-to-Peer relationships are defined as interactions between two or more people who are members of the same affinity group. With this system and method, instead of the organization acting as the main driver of relationship engagements, the task is decentralized to allow individual members the ability to conduct their own relationship engagements while the organization acts as the central cog, nexus or facilitator that encourages and helps these interactions to occur. See FIG. 2. Since the members organize the engagements and self-select which events, promotions and/or interactions they want to participate, the organization benefits because it now only has to manage and maintain the system the peers connect through. This dramatically reduces the cost for the organization to sustain engagement. Even though the peer/creator of the event replaces the affinity group as the organizer, the entity, as the facilitator, still retains and enhances the relationship with their customers who engage in the encounter.

In particular, as shown by the pathways 100 in FIG. 2, in the peer-to-peer model, members create a large portion of the engagements that drive the relationship state with the affinity group 1. Since there are almost always more members of the affinity group 1 than those who work for the affinity group 1, they can create more engagements than the affinity group 1 ever can. Also, because they know exactly what they like, they can tailor the engagements to themselves and their interests. As shown by pathways 102, as the organizer/facilitator of the engagements, the members transfer their engagement experiences onto the affinity group 1, thereby changing the relationship between the affinity group 1 and member (e.g., 1A, 1B, 1C, etc.) after each peer-to-peer encounter/engagement. With regard to pathways 104, the affinity group 1 still plays some central role in the peer-to-peer model; its effects are more limited because the members are doing most of the organizing, gathering and engagement activity. Thus, the affinity group 1 still organizes and interacts with their members, receiving all of the benefits of traditional, centrally-organized encounters; as members interact with the affinity group 1, their relationship state with regard to the affinity group 1 changes. Finally, the affinity group 1 provides the members an ability to connect through devices also referred to as “ecosystem/platform provided by affinity group.” This ecosystem can connect members together and notify them of occurrences, events and other engagements regarding/with other members.

Without the cost of the central style system, the peer-to-peer model allows the organization to multiply the number of engagements it can host, giving the affinity group potentially a much larger membership engagement history and interactions/encounters with its members. This data in turn provides the entity the ability to focus its limited resources and central engagement on more specific and high value targets (people who can purchase more because they are in a high engaged state or transitioning a specific group of people into a higher state). A hybrid model can therefore be developed where the organization can continue its central engagement activities in conjunction with the peer-to-peer method.

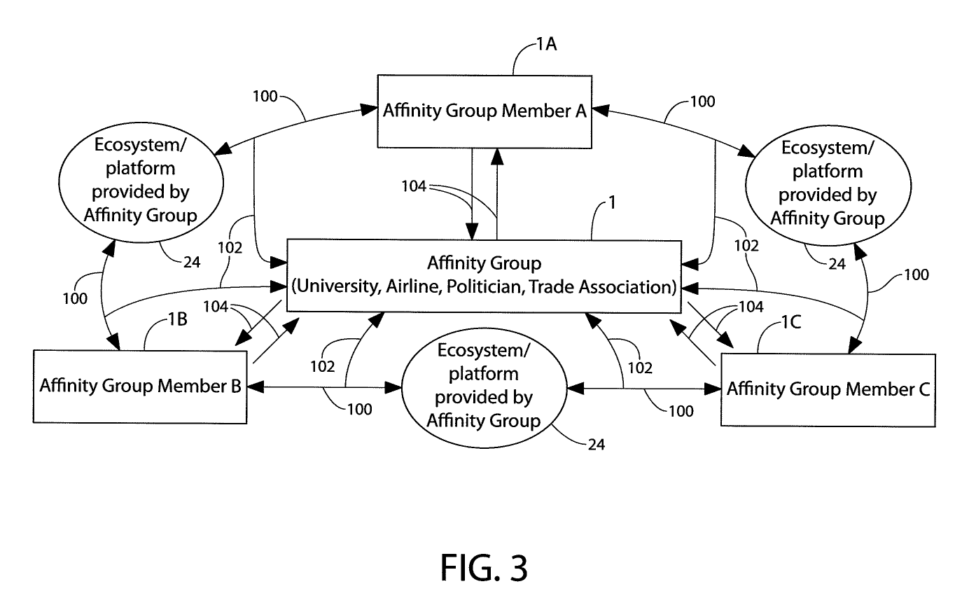

As shown most clearly in FIG. 3, where a hybrid affinity group model of the present invention is shown, the combination of peer-to-peer engagement and traditional engagement in the present invention is a powerful system/method to attract new clients, customers and supporters. This unique combination applies to numerous fields ranging from conferences to politics, retail, sports, non-profits, alumni relations, student populations, age demographics and any combination of a person's affinities. This invention provides a technique and system that enables affinity groups to build, manage, organize, support and engage customers. It combines the centrally organized/one-to-one relationship building of the past and the peer-to-peer relationship engagement of the present/future and captures/collects the results of this engagement in a more efficient way, thereby increasing the number of purchases and donations, as well as, growing the affinity group's total amount of funds. The “Asks” are not limited to physical goods and each affinity group can deliver promotional material/content as well as solicitations over devices for goods/services and/or donations before, during or after an engagement. The system and method do not necessarily have to combine central and peer to peer, it can also exist with using the two engagement tactics (central/peer to peer) separately.

The increase in the total number of engagements as a result of the peer-to-peer technique creates an interesting dilemma for the organization. With the sheer number of connections taking place, it is difficult in both systems (central and peer-to-peer) for an affinity group to fully capitalize (obtain new funds from additional purchases, donations or have positive/affirmative Asks) on the increased engagement produced from a positive encounter between members or a member and the organization. This is especially true where benefits from an encounter may be fleeting and without a proper method to solicit funds from any rise in state among members before, during, or after an engagement, the organization loses the opportunity as the member quickly returns to a lower state. Through this system and method, the invention provides a consistent formula for affinity groups to capture any positive increases in engagement state, which may lead to additional purchases or donations, among members and potentially notify the affinity group of any negative state change for member(s).

This invention provides a system and method for affinity groups to enable peer-to-peer engagement, raise the relationship state of their membership and increase the probability of members making a purchase combined with a vehicle to accept a payment for a purchase. The method also allows an affinity group to capture and solicit a member while they are in a higher state before, at or subsequent to an engagement activity. The system consists of a central server 22 (or group of servers 22) the affinity group operates; the affinity group can also choose to have a third party vendor run the system for them. The server 22 comprises software composed of machine readable and human readable code installed on it, enabling the management of the network (both peer-to-peer interaction and central based interactions). Users trying to interact with one another can use a device 24 to connect to the Internet/a telecommunications network and through the Internet link 26, access the server 22 and networking software. The member or user of the system and method 20 can typically use a mobile device such as a tablet, mobile phone (e.g., cellular phone, smartphone, etc.), netbook or laptop to connect with other members, but other non-mobile tools such as desktop computers can also be used to access the system. The software of the system can be accessed through a program/software that resides on the device 24 or through a web browser-based interface that has the ability to connect to the Internet.

The pathways 100-104 of FIG. 3, as discussed previously with regard to FIG. 2, also apply in the hybrid affinity group model and are therefore not repeated.

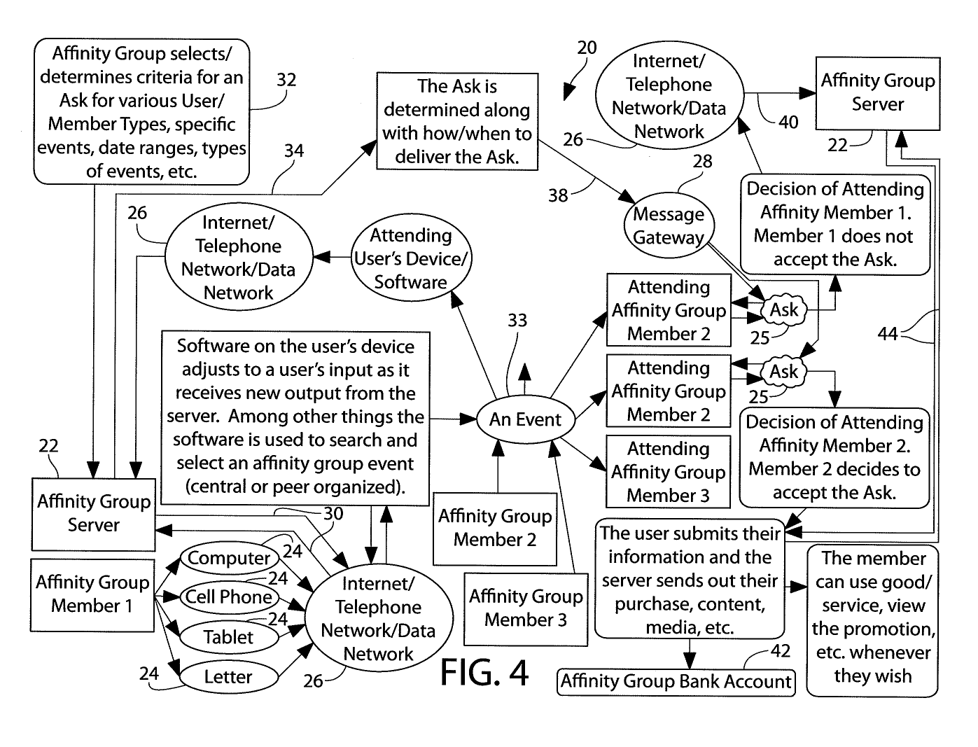

This invention provides a system and method 20 for affinity groups to enable peer-to-peer engagement, raise the relationship state of their membership and increase the probability of members making a purchase combined with a vehicle to accept a payment for a purchase. The system and method also allow an affinity group to capture and solicit a member while they are in a higher state before, at or subsequent to an engagement activity. As shown most clearly in FIG. 4, the system and method 20 comprises a central server 22, or group of servers 22, the affinity group 1 operates; the affinity group 1 can also choose to have a third party vendor run the system and method 20 for them. The server 22 can have software composed of machine readable and human readable code installed on it, enabling the management of the network (both peer-to-peer interaction and central based interactions). Users trying to interact with one another can use a device 24 to connect to the Internet/a telecommunications network 26 and through the Internet link 26, access the server 22 and networking software. The member or user of the system and method 20 can typically use a mobile device 24 such as a tablet, mobile phone, netbook or laptop to connect with other members, but other non-mobile tools such as desktop computers can also be used to access the system and method 20. The software of the system and method 20 can be accessed through a program/software that resides on the device 24 or through a web browser-based interface that has the ability to connect to the Internet 26. Message gateways 28 support the transfer of messages or content from a source.

In an embodiment of the invention, the system and method 20 can occur through the central server 22 loaded with machine readable code, software and/or algorithms each affinity group 1 sets. The server 22 connects to an affinity group's members through a user's device 24 linked to the server 22 through software and/or access to a web portal on the device 22 and a connection gateway 28 back to the server 22 through a data network, telecommunications service or the Internet 26. Members register using their device 24 and this registration information is stored on the server 22. The members can also sign up for and create engagements themselves through devices 24 (the affinity group 1 can create and attend engagements too), and these user created or centrally created engagements are stored on the server 22. When an engagement occurs, the server 22, through the information provided by members, a member's relationship history with the affinity group, similar members' relationship history, a user's purchase/donation history, similar users' purchase/donation history, the type of engagement, other attendees, algorithms and other co-variant variables, determines/predicts which users may be in a high state or identify users who may cross the threshold into a higher state as a result of the engagement.

From this list of information, the server 22 can determine, using many of the same variables, codes and algorithms above, whether or not to solicit the member for payment for a good, product, service or cause as well as determine a date/time (before, during or after the engagement) to make the offer. The affinity group 1 selects the good, service, product, promotional material, donation requested or cause offered using other variables/algorithms to determine what to offer/solicit and the frequency of the “Ask” (the interval between “Asks”). What to offer and the frequency can also be determined in a non-manual fashion through the affinity group's server(s) and algorithm(s). At the server's prescribed time and date, the server sends out a message through a message gateway (SMS text notification, email, push notification, in app pop up, phone call, etc.) to the user's device. The user can then decide through their device whether or not to accept the “Ask”, and the decision is sent back to the server 22.

If the member clicks in the affirmative, the “Ask” is triggered and the server can deduct the proper funds from the member's bank account or other source of funds (credit card for example) and transfers it to the affinity group's preferred deposit location (these funds may also be deducted at a later time). The server then sends back to the user through a predefined message gateway a receipt/confirmation and ships all the purchased goods or services to the member. This shipping can also include shipment of a special code, coupon or card that details a service/good the member can receive or purchase to their device. The member can then use this code/card to retrieve the physical good or actual service. The “Ask” can also include access to content either directly on the user's device, the affinity group's website/server or a third party site. The “Ask” transaction, whether the member successfully or unsuccessfully uses their code to obtain the good/service, their history of engagements with the affinity and purchase/donation history is recorded and stored on the affinity group's server. See FIG. 4.

With particular regard to FIG. 4, the user engages with the affinity group's server 22 through his/her device 24 which sends information to populate software that the affinity group member has downloaded, installed or received on his/her device 24. As the user makes new inputs, the server sends back different output based on the member's inputs. See pathway 30. The affinity group 1 selects how it measures when a user/member reaches a high engagement state. See pathway 32. This determination can be made manually by the affinity group 1 (which can set the variables/criteria, weight of each variable and threshold) or the affinity group 1 can set algorithms that take into account prior history and other factors to determine when a person reaches a high engagement state. These criteria can be set for each event (see item 33), each user, certain types of events, certain types of users, different criteria for selected date ranges, etc. As shown on pathway 34, the server 22 processes multiple variables (e.g., who is in attendance, how many friends are attending, how often the user attends an event with this type, etc.) based on the attendance data sent from each user's device 24. Based on this data, the server 22 determines whether a user has reached a high engagement state based on the algorithms set for the user/event or manual variable selections made by the affinity group. If the user is determined to be in a high engagement state, as determined by the affinity group 1, then the server 22 can generate an “Ask” 25. It should be noted that on pathway 36, the software/device 24 for each user who is in attendance sends information back to the user. On pathway 38, the server 22 determines the method to make the solicitation (e.g., email, pop-up on the user's device 24, etc.), what to offer/request (e.g., a promotion, request for donation, purchase of a good/service, etc.), the message (e.g., what content is contained in the Ask, including video/photos), when to make the Ask (e.g., before, during or after the event, etc.) and whom to solicit. The Ask then passes through the message gateway 28. As shown on pathway 40, the server 22 records the decision of each member who received an Ask. Members do not have to act/decide on an Ask immediately. As shown on pathway 42, if the Ask is a purchase or a donation, the affinity group 1 receives the funds. The member can pay directly through his/her device 24, pay later (e.g., if allowed with a check or other payment form, etc.), pay when he/she uses the item, or pay in installments. This may or may not occur through the user's device 24. The affinity group 1 may not receive the funds immediately and it may have to pass through third party accounts before the affinity group 1 receives the funds. Pathway 44 shows that upon acceptance, the server 22 transmits/arranges for the user to pick up/retrieve the goods/services, coupon, content, etc. If a payment is required, the user's software processes the payment before the server 22 sends anything. It should be noted that any number of members come together for an event 33 (e.g., either centrally or peer-organized). It should also be noted that that “attending affinity group member 3” in FIG. 4 did not receive an Ask because his/her information did not match the required threshold, variables and/or algorithm.

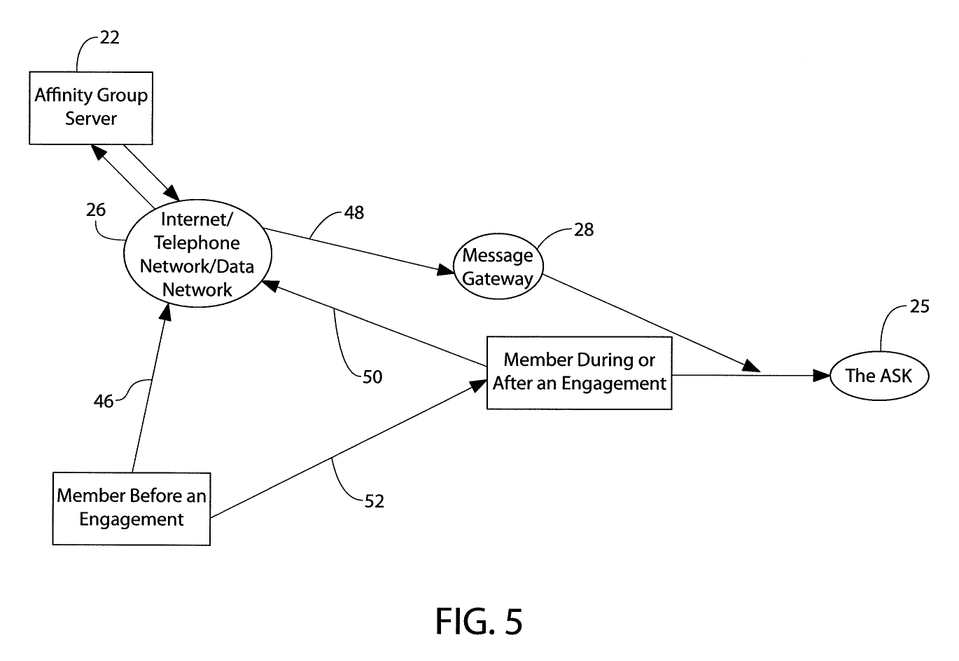

This system allows an organization to tap into the goodwill generated from events/engagements. See FIG. 5. Since the “Ask” is typically, but not necessarily, for small amounts, this method reduces the reluctance a member feels about making a payment. This reduced reluctance can result from any combination of the following along with others not mentioned here: a) the member may go into a higher state because of the event, b) the amount of the “Ask” seems trivial, c) the payment/donation method is convenient and efficient and/or d) the products, goods, services or cause are something that the members wants to support, own or be associated. Through this method, solicitations occur in a more efficient manner and without the need of affinity group representatives at an engagement. The invention can also predict when a person has the greatest likelihood of moving to a higher or the highest engagement state. With these predictions and member preferences (including likes and dislikes of products, goods, services, promotions, media, etc.), engagement history, purchase history, prior usage of goods, services, promotions and media along with other factors, the method can determine the proper channel/device/message gateway to send the “Ask”. In addition to choosing the “Ask” pathway, the method enables the affinity organization to determine a good, service, promotion, content, product or donation request that best fits the particular member and their predicted future state when the “Ask” is made.

In particular, as shown by pathway 46 in FIG. 5, a member's information is updated on the server 22 through the member's device 24 over the Internet, data center or telephone/data network 26. The server 22 contains and stores all of a member's information that he/she provides. The server 22 has memory to store this information and software to organize it on a database. The server 22 looks at the member's prior history, a member's data, number of friends at an engagement, engagement state prior to the event 33, predicted engagement history and other variables to determine (see pathway 48) whether or not to solicit something from the user through a message gateway 28. In addition to creating algorithms to automatically decide when and what to solicit from the member, the affinity group 1 can manually determine when to solicit the member through any number of messaging gateways 28. Also, during an event 33, the member's information may be updated on the server 22. This is accomplished (see pathway 50) through the member's device 24 over the Internet, data center or telephone network 26. A member learns about an engagement, either from a peer, an alert, notification, advertisement, finding it on the affinity group's web/mobile services or any other messaging gateway 28; if the engagement has a positive impact on the user, this raises his/her engagement state, as shown by pathway 52. With particular regard to the Ask 25, the Ask appears on the member's device. Members in a high state are most likely to accept the Ask. The member then decides whether or not to accept the Ask.

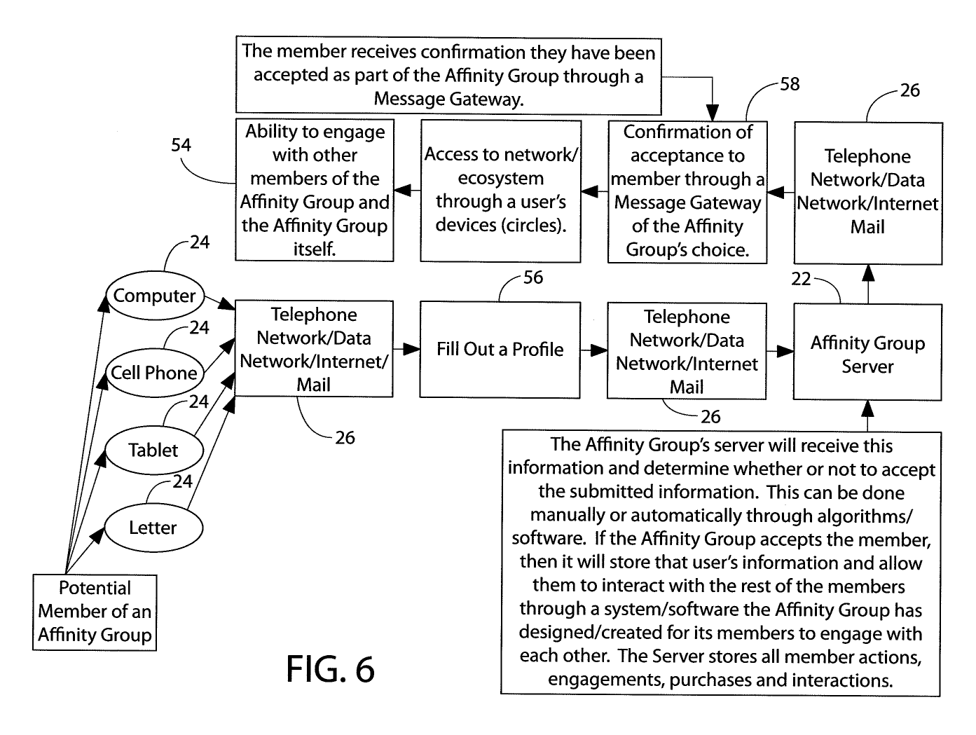

As shown in FIG. 6, the system can use some methods developed in social networking to organize people. Each affinity group determines the criteria for who may join their group and based on that decision, decides how to verify a prospective member's identity. At registration, each person can submit a variety of information through their device which is uploaded to the server so that the system can identify them. This verification procedure can range from a simple sign up from for a political cause with only a few fields, such as name and address, to validating each submitted field to ensure, for example, that a prospective user is a member of a certain graduating class from a specific university. To verify a user, the system may ping a second server or set of servers which contains that affinity group's membership data and using software and/or algorithms found on the first server, check and verify the prospective user's information with known information on this second database. The second server can then give a response based on the submitted information. If the response is positive, the user is allowed to join the system. While this sequence can be typical, it is also possible that all of the necessary verifiable information could reside on the same server that manages the overall network.

In particular, as shown in FIG. 6, a potential member of an affinity group registers through his/her choice of devices 24. The member's request is sent over the selected network (26) which depends on his/her device 24. Members can interact 54 with other members through the affinity group's services, software and systems. Members can also engage with the affinity group and receive promotions, Asks and messages from the affinity group as well as complete transactions, such as purchases, viewing content, making donations, etc. Along with a request to join the affinity group, the user completes a profile 56 that contains basic information such as name, contact information (e.g., email address, cell phone number, mailing address, etc.), interests, etc. The affinity group's server 22 receives all of this information and determines whether or not to accept the submitted information. This can be accomplished manually or automatically via algorithms/software. If the affinity group accepts the member, then the server 22 stores that user's information and allows that member to interact with the rest of the members through a system/software the affinity group has designed/created for its members to engage with each other. The server 22 stores all member actions, engagements, purchases and interactions. Once accepted, the member receives confirmation 58 that he/she has been accepted as part of the affinity group through a message gateway 28.

The information users provide for identification and the methods to verify each user can also reside on the server. At the time of registration, an affinity group may require a prospective user to submit additional information that together with the required registration fields can constitute a user's profile. A profile contains multiple fields of information including cell phone number, payment information, email address and possibly home address that identify the user and allows other users in the same affinity network to identify, contact and find matching users. A user can change their profile information on the server through the program on their device. This profile information, which is stored on the system's server, enables the system/server to match users based on different filters to determine ideal matching groups based on profile information, event history, member location, etc.

Users can also self-select, using a list of filters, to find matches. For self-selection, a user can open their device, select different filters to place on the affinity groups' membership list and click a search button. The search parameters can be sent to the server 22 and the results returned with a list of matching users and their profile information. Depending on the relationship between the searching user and the user(s) resulting from the search, different amounts and parts of each user's profile information can be displayed to the searching user.

The information displayed can be dependent on the searched for user's privacy setting for the specific searching user or the searching user's User Type. Users can set location privacy as well, which determines who can see their location at regular intervals or on a continuous basis. To set privacy and location instructions, the member uses their device to toggle on or off various privacy/location settings for specific users or User Types. This information is then sent, stored and updated on the server through a connection link along with the user's profile information. Whenever a search or call is made to display a user's information or location, the server checks the user's privacy/location settings against the person making the search query. If the searched for user allows certain pieces of information to be displayed to the searching user or User Type, then the information can be sent from the server to the searching user's device though a message gateway. Users of the same affinity group can have multiple connection points and communication vehicles available through programs/software running on their devices, including being able to message each other through services such as messaging or wall posts, instant message or chat, SMS text, phone calls and email.

A person can use a mobile device and the GPS or other location finding functionality on their devices to locate other members of the same affinity group that are around them. In one embodiment of this invention, making a peer-to-peer connection through a device and server link raises the member's engagement state or makes them more likely to purchase something/make a donation. After calculating whether or not to send an “Ask” from the people at such an engagement, the server has software to handle payments and/or donations. This payment software can be custom built for each group or from a third party vendor who can process such payments. If any merchandise is being shipped, the server/software can handle procurement and shipping of the required material. In return, the user can receive a payment receipt and access to the goods/services/content purchased. Promotional material can range from videos, pictures and other media to promotional offers and coupons for goods and services from companies the member may like and/or are in the member's current area. Payment does not necessarily have to be made immediately following an acceptance of the Ask. Instead, the affinity group can set for each user, User Type, Ask, etc. when the user is required to pay.

When searching for users, the searching user also has the ability to filter the results using various selectors such as name, class year, interests, distance, activities, if other users on the network are designated as a friend, etc. The user selects which filters they want to use and then the server returns the results based on the GPS location or other location-discerning methods and the selected filters to the user's device. The user has the ability to see these results in a list form or view the location of the resulting users on a map that can display everyone's location on their device 24. The user's results depend on the searched for user's privacy settings. The affinity group's server can also provide this information along with various places (restaurants, bars, cafes, etc.) from another source it is connected to through the Internet which contains information on places the server suggests. The users can have the ability to filter and choose which place data they wish to see. With the user and place data, a member can create an impromptu, user-generated event and invite a specific set of individuals, including all members on the network, to the created event.

These events can span a wide range of activities from sports to dinner at a home, attending a theater production, etc. Because the affinity group is enabling the various users to come together, the affinity group becomes the connector and central point for these users. As the ‘glue’ holding these relationships together, the users ascribe the benefits (socializing, networking, helping the poor, etc.) to the affinity group, making these engagements part of their relationship history with the affinity. The key is that the users themselves create and facilitate the engagement with varying degrees of, but typically little, help/direction from the central organization. See FIG. 2. This exponentially multiplies the number of engagements the affinity group can host, increasing the number of engagements between the member and group as well as possibly raising the member's engagement state. The peer-to-peer event creators (members of the affinity group) also become grassroots ambassadors and promoters for the organization and reach out on behalf of the affinity to other people who may not be engaged (in a low state) or even affiliated with the group and recruit them to join. The affinity group can supplement these impromptu meetings (Meetups) with events of their own, using user provided information on the server to target and focus their events and promotions.

Using a political campaign/the campaigns' supporters (the affinity group) and a mobile phone application or app (the device), find an example of how the invention would work:

At the end of a political rally everyone is excited about the campaign and the energy is high. However, after the potential voter leaves, what happens? For most people their excitement level drops because they are no longer interacting with the candidate or anyone else on a consistent basis. While mailers, emails and other methods work for disseminating information, too often, there is very little physical interaction between supporters and these outreach vehicles rarely build a solid, sustained or continuous link between an individual and the campaign. What is missing is continuous, interactive engagement between supporters on both an impromptu and formalized level. Since the campaign cannot be omnipresent, establishing connections between individual supporters and encouraging their interaction on a one-to-one level becomes crucial to motivate them to actively support the candidate in their community, which the app accomplishes through its impromptu event organization. Engaged voters not only serve as campaign ambassadors and recruiters to their friends, but will also be the most likely to donate time and money.

Instead of the campaign trying to manage and encourage each voter engagement and interaction through a centralized one to one relationship, the app empowers users to connect with each other through a peer-to-peer platform. This occurs through the app's suite of services and a system designed to encourage spontaneous and impromptu connections between various supporters (Meetups). The Meetups occur in “Real Time” at any place—be that in line at Starbucks or waiting for a train at Grand Central Station—users now have the ability to see who is nearby that shares their affinity and make a connection. A user can turn on the app and then select a set of political beliefs they support and a distance radius. The search criteria, in this example the user selected set of political beliefs, goes out across the telecom wireless infrastructure and connects to a server 22 for the user's affinity group with the various user profiles, which contain their political beliefs. The server 22 pulls the location of the users on the network and checks if any people are within the user's distance criteria. With the list of users within a set distance, the server 22 uses algorithms and software to suggest a set of users who match the users filter criteria of political beliefs. The server 22 then returns the matches to the user's device 24. Through the app, the user can also search the different meeting venues (restaurants, bars, cafes, etc.) in a prescribed or selected area (by the server 22 or the user) and then based on filters the user sets (price of food, distance, type of place, etc.), return a list of possible places to meet. The server 22 can perform the same actions.

The user and venue list can also be displayed in a map view output form where the users and places are placed on the map at each person's and place's location. The map is viewable on the app and can also have filters applied to it. The user who performed the search can contact the results of the search (either user or place) through a message gateway, see user or place details, share user or place details and create an event at a selected place. When a member creates an event, the creator selects a location or a place for the event on the app. After selecting the initial event information, inviting others to the event and creating the event on their device, the event information and invite list are sent to and posted on the server 22.

Once on the server 22, other members can view the event on their devices (in a map or list view) as well as RSVP to that event, with the server 22 notifying all invited users about the event. These invited users can receive a notification in the form of SMS, email, phone call, push notification, in-app notification, etc. from the server 22. After posting to the server 22, other users can see and search for the event's information as well as see its location on a map view in relation to other users, places and events. Every user has the ability to filter their map by any combination of users, places and events.

With the Meetup model, the app increases goodwill toward the campaign and engages supporters as they interact with each other, and because the users create a majority of the events, the app multiplies the campaign's ability to host and organize tens of thousands of interactions without expending any additional resources—in other words the users self-direct the activities under the umbrella of a political campaign.

When the system and method 20 brings together people at a formal (organized by the affinity group) or at a Meetup (user created) event, the server 22 and algorithms calculate whether or not to ask for a payment for a good/service, content, promotion or a donation. The server 22 sends a message through a message gateway 28 (a SMS, text message, push notification, pop up message on the device, email, etc.) to the member's device 24, giving the user the option whether or not to make a payment. Determining the price/product or donation amount can be based on a variety of factors and variables such as event type, people/friends in attendance, frequency of attendance, amount previously paid through the device 24, etc. Each affinity group can set the weight of the variables and which ones are included in the decision to make an “Ask” engagement. Affinity organizations can develop and adjust the algorithms that target specific User Types and/or individuals.

The details of these individually targeted “Asks” reside on the server 22. The payments are typically small (micropayments/donations) to capitalize on an impulse buy mentality, but they can vary considerably and include large amounts. Each user has the choice of selecting the suggested payment/donation amount or choosing his/her own from a variety of choices (prices for products, services, and donation amounts) that change based on the event. For some products/payment amounts the user may not have a choice and in order to receive the good/service being offered, the user must accept the suggested payment. The timing of the “Ask” can also be determined by another set of variables and can be different for and set by each affinity group. Asking for a payment/donation directly through the device 24 at the time of, before or after an engagement event capitalizes on the idea that attendance at affinity group events creates a spike in the user's engagement/relationship with the affinity group that may also raise the user's state to one open to purchasing or donating. These engagements can serve to sustain a member at a high engagement state. This method (requesting donations or payments during an event or while the high state effect from the engagement lasts) also allows an affinity group to capture the goodwill and state changes of the user as a result of the engagement and target the user while they are ‘in the moment’, increasing the probability of a successful “Ask”. The ‘Asks’ can be set manually (the affinity group manually sets them) or automatically (where algorithms and software determine the various variables and settings for the Asks).

In this embodiment of the invention, an affinity group has a server 22 with machine code, human readable code and software. This server 22 and its information are accessible through the Internet or other type of data connection such as a telecommunications relay. A member of an affinity group is connected to the server 22 through the Internet, phone call, telecommunications network or wireless Internet through a device 24. This device 24 contains software or other systems that link it to the server 22. Members or the affinity group can create engagement opportunities for members. These range from concerts to political rallies on a large scale down to small group gatherings at a park or a customer service call.

After the engagement is created and members register for the engagement (through their devices connected to the server), the engagement's data (date and time of engagement, attendees, type of engagement, cost, etc.) can be transmitted and stored on the affinity group's server 22. The transmissions can come from a member's device 24, a web portal, a web browser or another server 22 that the affinity group does or does not control/manage. Based on this data, the server 22 can examine each member involved in the engagement and decide whether or not to generate an “Ask” for goods, services, coupons, content, rebates, deals or a donation. The “Ask” is broken into four possible parts: whether or not to request, the amount requested or goods/services/coupons offered, the timing of the action and frequency.

The affinity group establishes the variables that dictate whether to generate an “Ask”. The variables (not a full list) that affect a decision to generate an “Ask” can include information/data from a member's profile, their past event/engagement history, payment and donation history, a similar User Type's profile information, a similar User Type's past event/engagement history, a similar User Type's payment and donation history, attendees at the engagement, friends at the engagement, score in a game, the total score of a game, the location of the member relative to other members/friends, an occurrence/trigger at an event (number of people attending, a certain action taking place, etc.), the location of the member at the time of the engagement, an event occurring at the engagement or even a manual setting by the affinity group to ask all or a selection of those attending the engagement.

The amount, good, service, content, coupon or donation of the request (the second part of the “Ask”) is based on another set of variables similar to the ones above. For the timing of the “Ask”, the server 22 looks at a third set of variables and decides if the “Ask” should occur before, during or after the engagement as well as the specific time and date to send it. The final factor, frequency, determines how much time must pass since a previous “Ask”. Multiple factors can affect the frequency, including time between engagements, engagement type, cost of the engagement, payment history, and time since previous individual, User Type or group “Ask(s)”, etc.

When a member matches the criteria set for whether to make an “Ask” (an affinity group can set multiple “Asks” for each engagement), the server 22 sends the “Ask” to that member. This “Ask” comes as a message through a message gateway 28 onto the member's device 24. The member has the choice to accept or reject the request. The member may also choose to take no action at the time of receiving the request and make a decision later. If the “Ask” does not immediately reach the member on his/her device 24, it can be stored (either on the server 22 or the device 24) until the user accesses the request, sent through a second or third message gateway 28 or delivered through another device/medium.

Each “Ask” can show some combination of information, product links to other pages on the Internet, media, a message, promotional material and/or an amount requested. The user can learn more information about the good/service/cause/donation/promotion by clicking links either on the “Ask” that take the member to other parts of the device, the Internet or other display mechanism with additional information. The additional information can also be sent to the device from the server. The member may have a choice in the amount paid for a good, service, promotion or amount donated. The affinity group can determine whether they have a choice and the range of options, including any amount they wish and no choice (the user must accept or reject the request), for each “Ask”.

To accept an “Ask”, the member clicks the affirmative choice on his/her device 24. This action sends a signal back to the server 22, notifying it of a successful solicitation. The server 22 then sends instructions on payment method along with the ability to enter payment details to the device, web portal and/or web browser through a message gateway 28. The member enters their payment details and can then confirms his/her desire to accept the “Ask”. If confirmation is required and upon receiving the confirmation, the server 22 deducts the “Ask” amount from the user's selected payment method, including but not limited to a credit card, Pay Pal or withdrawal from a bank account for example, and adds the funds to the affinity group's account. The funds can also be stored in an interim account before being migrated over to the affinity group's account. Payment does not necessarily have to be made immediately following an acceptance of the Ask. Instead, the affinity group can set for each user, User Type, Ask, etc. when the user is required to pay.

After successful processing and receipt of payment, the server 22 can send a confirmation message/receipt back to the user's device 24. It may or may not send a second message or attach a message to the confirmation message. This second message could contain a coupon, code and/or a confirmation letter alerting and confirming a prospective affinity group that the member is entitled to a set of benefits, goods, services and/or reduced rates on offerings. The good, service and/or reduced rate on a good/service could possibly be obtained through a third party that is not part of or related in any way to the affinity group. A time limit can also be placed on the redemption of such a reward/benefit. An example of this is if the “Ask” entitled a member of the Automobile Club (affinity group) to receive X number of widgets for free from Company X, Y, Z, but they had to take possession of the widgets within seven days of acceptance of the “Ask”.

If any products or goods need to be shipped to the member, the server 22 can process the order and have the relevant materials sent to the member. These materials may come from a third party company, and the affinity group's server 22 establishes procedures to alert the third party regarding acceptance of the Ask and where to ship the material. If the member responds negatively to the “Ask”, a message is sent to the server 22 noting this reaction. The reaction, either positive or negative, can be stored on the server 22. Any and all of these steps can be combined and/or eliminated depending on the affinity group, the members of the group, the amount and type of “Ask”. This example should not be taken as limiting in any way.

The “Ask” may not necessarily be for funds and may or may not contain media/content that can be displayed directly on the device or through it. The “Ask”, if accepted, may also unlock specialized content or media provided by the affinity group or a third party on a website, the device, in a physical space, etc. The “Ask” for these promotional, content or media type “Asks” can be handled in a method similar to the one described above.

For the Peer-to-Peer events, the affinity group has to do very little work. When a user reaches an active state as defined by the entity, the method provides a way to capitalize on it, secure a payment/donation and enables the group to keep a user in the active state for an extended period of time (through more relationship engagements, specific peer-to peer events, etc.) in a sustainable manner.

In another embodiment, this system and method 20 transforms the way individuals associated with an affinity group receive benefits because of the way it solicits funds for the affinity. Using an alumni association as an example, many alumni associations provide a prescribed set of benefits (a football ticket lottery, university club membership, special access around the campus) for different levels of donations. Most people, especially on the smaller donation levels, receive the same benefits as every other donor at that level even if they have different tastes or needs (they do not like football for example but still get put in the football ticket lottery). Additionally, a school typically requests a donation from alumni in large, single blocks. If the donor agrees and sends in the money, the donor usually does not receive the benefit until sometime in the future. In contrast, this method brings the benefit into the immediate/present term, allowing the user to feel the reward/use the benefit right away.

When an alumni decides to attend an event, they can do so with their device 24 which can register the user for that event and store this decision on the server 22. When the event occurs, the server 22 can determine, through the process described above, whether to ask for a donation. By this act of deciding to attend an event, the user is self-selecting the events where they can get the greatest benefit. Thus, when the server 22 asks the alumni for a donation, which the alum can pay for directly through his/her device 24, the system and method are allowing the user to customize the benefits he/she derives from being a part of the university's alumni affinity group. In a sense, just as a person can now download individual tracks of an album to create a customized library of songs, this system and method allows people to create a customized library of social experiences rather than the one-size fits all benefit levels.

Combining the Peer-to-Peer and central models increases the number of possible engagements with members. This also means that instead of having to ask for large requests because the affinity group has little interaction with the members, these requests can be broken into smaller, more numerous solicitations based on the increased number of potential interactions. Breaking down the total amount solicited makes the member more likely to accept the request and makes microdonations akin to purchasing a product on layaway. In layaway, a retail store allows a customer who does not want to purchase an item outright to make small payments towards the item, making it psychologically easier for the customer to justify the overall purchase.

This model is not limited to alumni networks either and can be applied to all different kinds of affinity organizations. For example if a person was at a sporting event, their device could inform them of other users that fit their desired profile at the same event and lead them to a connection point/place through a messaging or map-based system on a member's device, which is connected to a central server. After the members come together, the server 22 calculates (based on data inputs for all involved) what types of promotions, merchandise, media/content, advertising or coupons to offer them based on their profile information, prior history (event, product purchase, etc.), people they are meeting, interests and any other information provided (not a complete list). The member could then receive a message from the central server if an “Ask” was triggered. After receiving the “Ask” on their device, the member could then make a choice whether or not to purchase the good/service or watch the promotional material. Multiple connections could be made throughout a single sporting event too, connecting users with varying interests throughout the time spent at the venue.

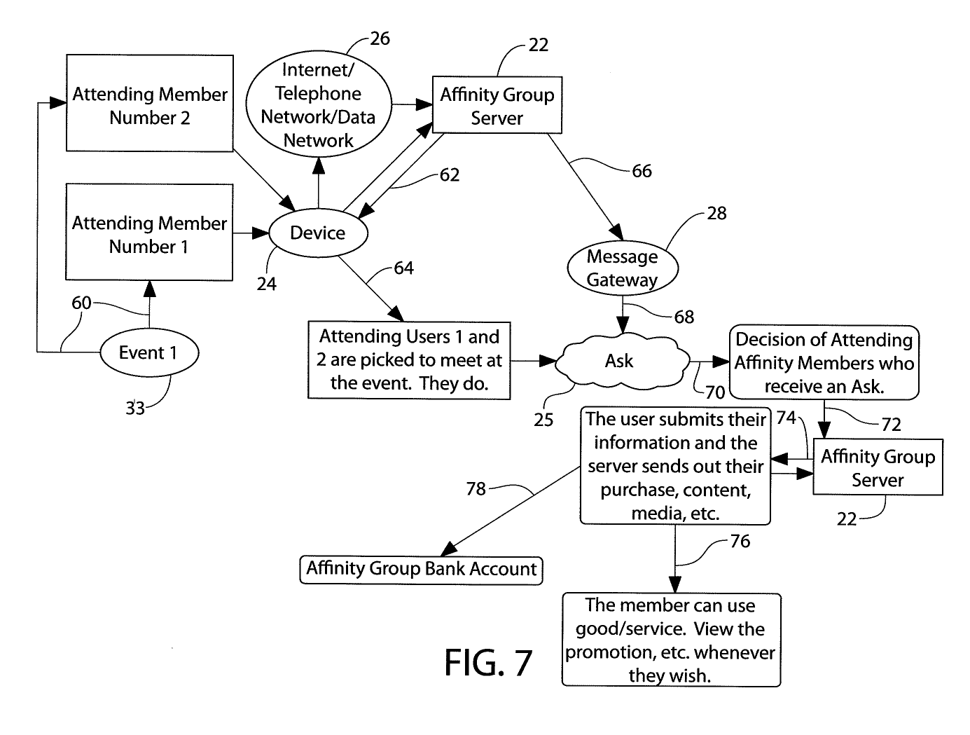

In particular, FIG. 7 depicts an implementation of the system/method for matching members at an event, determining solicitation to be Ask'd and obtaining the Ask. Pathways 60 depict users attending an event 33, check their devices 24 and load their software for the affinity group that is on their device. Pathways 62 and 64 depict attending members 1 and 2 are picked by the server 22 to meet based on their selected characteristics, event history, user type, etc. Members can also meet on an impromptu (i.e., not selected by the server 22) basis. The server 22 tracks interactions between the people at the event 33. After the members come together, the server 22 calculates (based on data inputs for all involved) what types of promotions, merchandise, media/content, advertising or coupons to offer them based on their profile information, prior history (e.g., event, product purchase, etc.), people that they are meeting, interests, and any other information provided. The member would then receive a message from the central server 22 if an “Ask” was triggered. Pathway 68 represents the server 22 giving each user/member different Asks 25 based on the information stored on the server 22 for each member, the affinity group's algorithms and/or software. Pathway 70 represents after receiving the “Ask” 25 on his/her device, the member can then make a choice whether or not to purchase the goods/service or watch the promotional material. Multiple connections could be made throughout a single sporting event (by way of example only) too, connecting users with varying interests throughout the time spent at the venue. Pathway 72 reflects the server 22 storing the user's decision on the Ask. Pathway 74 depicts upon acceptance, the server 22 transmits or arranges for the user to pick up/received the goods/service, coupon, content, etc. If a payment is required, the user's software on his/her device processes the payment before the server does anything. Members may not have to pay for the service immediately; instead, he/she may have the option to pay in installments, send in cash/check, pay when using the goods/services and/or pay at another time (e.g., determined by the affinity group). Pathway 76 depicts the server 22 storing when the member uses or activates the goods/service, coupon, content or promotion. Pathway 78 depicts if the Ask is a purchase or a donation, the affinity group receives the funds. The member can pay directly through his/her device 24, pay later (if allowed with a check or other payment form) or pay by installments.

Another example is when a person goes to the theater. In this example, the theater company and attendees can serve as the affinity group and a mobile app on cell phone serves as the device 24. While at the theater, the server could match users of the app by filterable interests so that they can connect during intermission. Right before intermission, a user could check their mobile device 24 to see which prospective matches the server 22 sent them through a message gateway 28 regarding other attendees that share similar traits. If the user accepts the server's invitation to connect, it could invite them to meet the matching users at a specified place (selected by the user/peer, central system or automatically by the server).

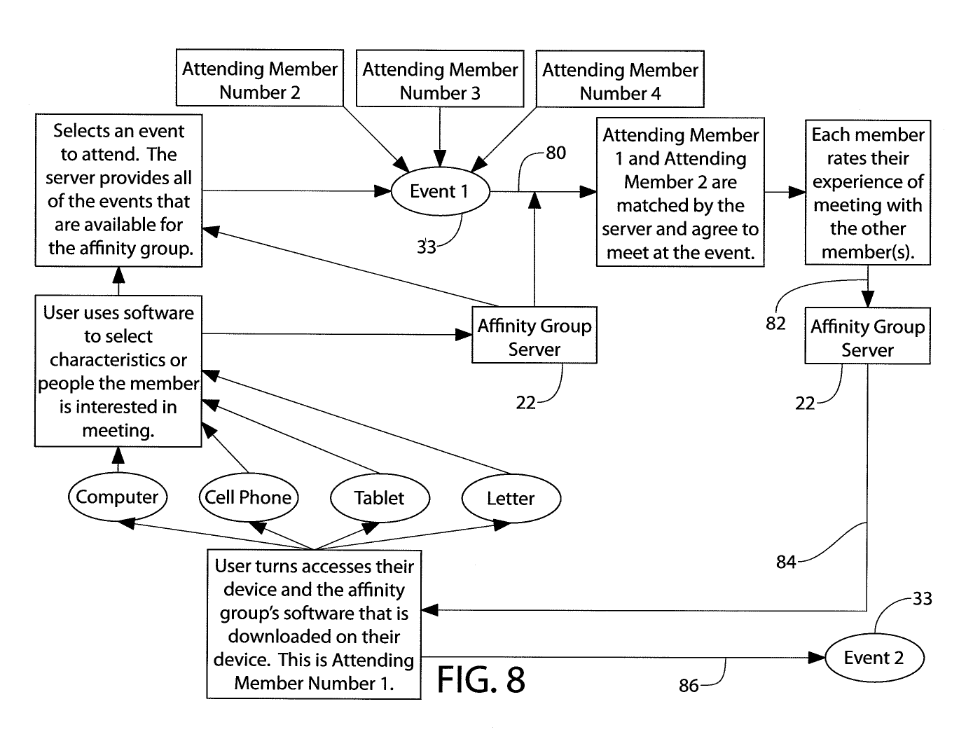

In particular, as shown in FIG. 8, all attending members set the characteristics, types of users and/or people that they are looking to meet at the event 33; all of this information is saved on the server 22. Pathway 80 depicts based on each user's selections, the server 22 suggests different people to meet before, during or after the event 33. The server 22 may even possibly provide users with options on where to meet. Pathway 82 depicts ratings from each member are sent to the server 22. If the members rate their experience positively, then the server 22 stores them as members who should be connected again. If not, the server 22 stores this negative rating as well and will, most likely, not reconnect these members. Pathway 84 depicts the server looking at the user's upcoming events, the affinity group's upcoming events and any other user's (who member number 1 marked as a positive experience) events and suggests to user member number levents where they should attend and meet both new users as well as reconnect with other members with whom they previously had positive experiences. Pathway 86 depicts based on the server's 22 suggestions, member number 1 receives suggestions of events to attend along with the ability to attend those events with selected users with whom the user had a positive experience in a previous meeting.

After the encounter, each user can rate the Meetup and submit the ratings back to the server 22. If the survey ratings exceeded a certain threshold (the group of people enjoyed meeting each other for example) that each affinity group can set, the server 22 might send out a subsequent message to the user's device 24 the day after the theater with various promotional deals, memorabilia to buy and an ability to purchase future tickets to the next production and sit with the same group the user had just met. After the notification of the “Ask”, the user can purchase these tickets and items directly through the mobile device or even on a non-mobile device. This combination of a traditional, centrally organized event (the play) with the impromptu Meetup (socializing during intermission) customizes the traditional experience for the user and provides an entirely new peer-to-peer relationship building model for the affinity group with the ability to raise people to higher engagement states. It also gives the affinity group new avenues to raise funds through payment for more goods, services and/or benefits before, during or after engagements through the “Asks”.

The final part of this method deals with the data/backend side. As users access the service (through their mobile devices), the server 22 and affinity group can track their location (through GPS, Wi-Fi or other methods such as if the user makes a purchase through the device 24 at a place where the server 22 knows the location of the place). It also tracks how each user and all users in attendance at an event respond to different stimuli that influence them to go to a desired location at the event, travel a certain route or make purchases at specific spots. For each affinity group engagement in addition to the member's movements tracked through location technology (updated at regular intervals on the server), the server 22 has member purchase data, when/where/with whom impromptu Meetups successfully form/formed, a map of various obstacles/barriers intentionally or naturally placed that affect crowd flow and/or a list of goals the affinity group wishes to achieve as part of the engagement. The goals of the goal list do not necessarily need to be accomplished during the engagement.

Instead, the affinity group can try to achieve them within a certain time period or track how long it takes to achieve the goal(s) such as: how long does it take/how many engagement are necessary to move a member or group of members into a predefined/selected state. Before an event, the server 22 uses the method outlined and the previous interaction history of the members in peer-to-peer and central based engagements to determine how to get a user to accomplish the event's goals. See FIG. 4. The server 22 returns with recommendations and suggestions outlining the best way to achieve the desired results and based on these recommendations, send users options that match the suggestions. The server 22 predicts which members are most likely to raise their state as a result of the engagement and which state they will enter. After an event, the server also determines how successful the affinity group was in achieving these goals as well as compare it to other member engagements the affinity group has held.

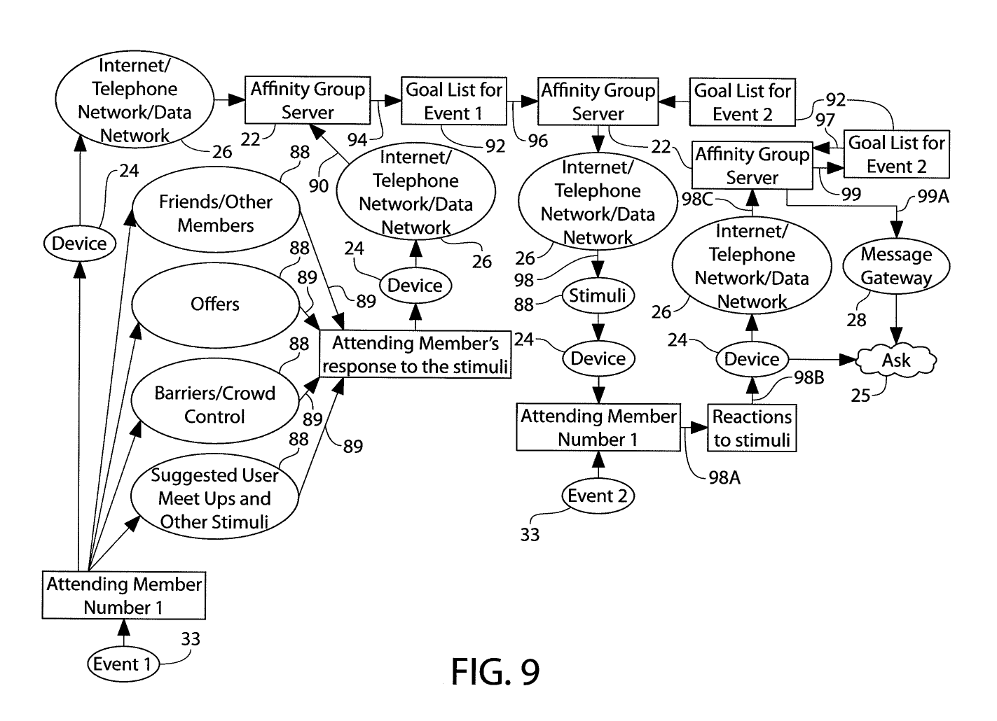

In particular, as shown in FIG. 9, a user (e.g., attend member number 1) interacts with different stimuli (e.g., friends/other members, offers, barriers/crowd control, suggested user meetups and other stimuli, etc.). The server 22 tracks how the user reacts to various stimuli as shown by pathway 90. As shown by pathways 89, the affinity group can structure obstacles/crowd flow techniques at, for example, an art fair; the server 22 stores, analyzes and determines how successful such techniques were to direct users to, for example, “Restaurant Row” and to encourage users to create meetups with their friends or people who share similar tastes in art at the restaurants. The server 22 also alerts users, based on proximity, similar interests, etc., to other users that they may want to meet with. The server 22 can suggest the formulation of meetups between selected members, as well as, suggest a time and place to meet. This message is then sent to the users in this group who can then decide whether or not to accept the meetup invite. Based on how the user reacts to the stimuli, the server 22 matches this against a goal list 92 that the affinity group has created for that user, user type, event, etc., as shown by pathway 94; in addition, the server 22 also stores how the user reacts to the stimuli and which goals are achieved with which stimuli or combinations of stimuli. Pathway 96 depicts based on the goal lists from previous events, the user's reaction to stimuli at those events and other variables, the server 22 decides how to achieve the goal list for the next event that the user and/or other members attend. Pathway 98 depicts based on the previous data, the server 22 sending user stimuli through the users' devices or suggesting ways to operate/setup (with barriers or crowd control), the event 33 to try and affect a member's decision so that they can accomplish the goal list 92 set for the event 33. In pathway 97, the server 22 marks/stores which goals are achieved for each user and for the event 33 as a whole. In pathway 98A, the member reacts to the stimuli; in pathway 98B, the device 24 transmits to the server 22 how the user reacted to the stimuli to the event 33; and in pathway 98C, the server 22 records the member's reactions. In pathway 99, based on how the user reacts to the stimuli, the server 22 matches this against the goal list 92 that the affinity group has created for that user, user type, event, etc. The server 22 determines how many of the goals were accomplished and then records which ones were achieved and which ones were not achieved; examples of goals comprise: getting a member to eat a certain restaurant, show up in a certain area, connect with particular friends or a particular number of friends, etc. The server 22 determines afterwards how successful the server 22 was in getting the user to achieve the goals and how to adjust for the next event. In pathway 99A, depending on the goals accomplished, reactions to stimuli and/or the server 22 deciding that the member has entered a higher engagement state, an Ask may be triggered and delivered through a message gateway 28. From this list, they could send those users a coupon through a message gateway 28 an invitation to attend a dinner with the other people who share the same interests as the ones they met at the previous meetup. The server 22 can track the success and failure rate for various types of users, separating them by any combination of art, interest, gender, age, etc.

As shown in FIG. 6, using an art fair hosted by the downtown restaurant association to illustrate this point, the association could create a mobile phone app and online web portal to allow city residents (the members of the downtown affinity group) to preview the various art exhibits, see if friends are attending the event, etc. The association's (the affinity group) goal is to get the art fair attendees to pass by “Restaurant Row” (the street where all of the association's restaurants are located) and make a purchase at one of their restaurants. With this system and method, the association structures obstacles/crowd flow techniques at the art fair, which the server 22 stores, analyzes and determines how successful they were, to direct users to ‘Restaurant Row’ and encourage users to create Meetups with their friends or people who share similar tastes in art at the restaurants. The server 22 also alerts users, based on proximity, similar interests, etc. to other users they may want to meet with. The server 22 suggests the formation of a Meetup between selected members, as well as, suggest a time and place to meet. This message is then sent to the users in this group who can then decide whether or not to accept the Meetup invite. The next day, the server 22 analyzes how successful the entity had been towards accomplishing the overall goal and can produce reports on this topic. The association also pulls from the server 22 all those people who attended a Meetup and made a purchase at a downtown restaurant.

From this list, users are sent a coupon through a message gateway 28 and/or an invitation to attend a dinner with other people who share the same interests as the ones they met at the previous Meetup. The server 22 tracks the success and failure of the association to achieve its goals and determines the success/failure rate for various types of users, separating them by any combination of art, interest, gender, age, etc. The system and method also helps solve the ‘Random Walk Problem’ because the server 22 shows exactly what stimuli, obstacles, events or promotions caused the user or type of user to deviate to the affinity group's desired outcome at various time intervals. The server 22 also determines which, if any, “Ask” or Meetups succeeded in directing/pushing a member toward the goal(s).

The “Pulse” is the macro version of this method and it combines data collected from a group of engagements (the affinity entity determines the set, including all engagements) or members (the affinity entity determines the set, including all engagements). The Pulse creates a representation of how engaging a series of engagements were and how engaged a set of users are/were. Based on the engagement history, the “Pulse” predicts how engaging/successful future events will be. To select the group of engagements or members, the association selects filters to sort the members and engagements that the server 22 has stored over time. The “Pulse” delivers a report and/or graphical representation of the engagement level generated by interactions/engagements or how engaged a particular part of the member base is. The “Pulse” can also model the engagement activities between groups or sets of members determined and established by the affinity group.

The “Pulse” is divided into various engagement state types too, showing how low state members are interacting versus high state members. Just as with the individual engagements, the affinity group tests the “Pulse” and sees how different stimuli affect interactions, affect movement between engagement states and purchases/donations for various segments of its membership. This “Pulse” also provides an overall ‘score’/average that like a stock price, index fund's price or consumer sentiment number can oscillate over time based on engagement activity from peer-to-peer/centrally organized engagements, giving an organization an idea and overall representation of how engaged their membership is. This score can also be segmented by any combination of filters the affinity group deems appropriate, even down to a specific individual. Finally the “Pulse” identifies in real time (preferably), or in near real time (updated at a regular interval), new members coming together in locations previously unknown to the affinity group and alerts the affinity to the new members' presence.

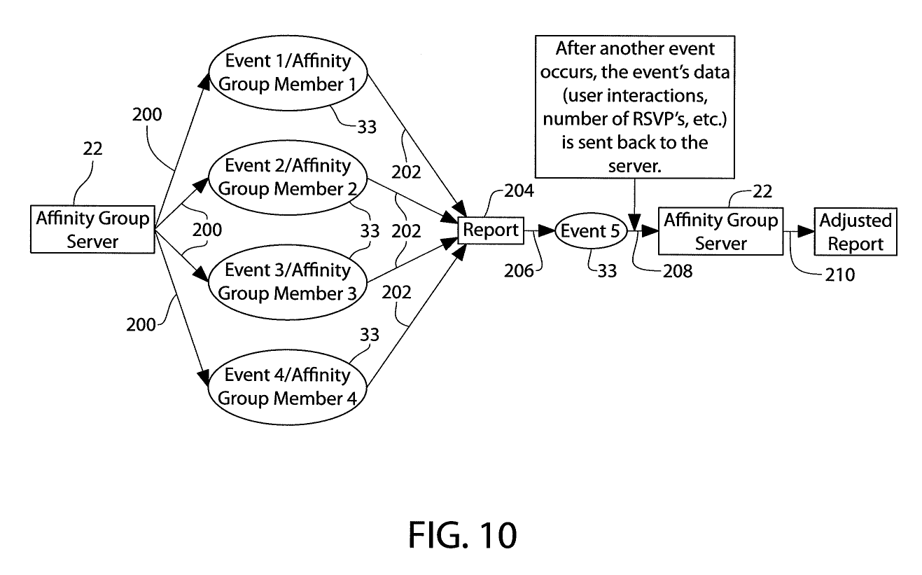

In particular, FIG. 10 depicts operation of the “Pulse”. As shown by pathways 200, the affinity group 1 selects a group of events, all events on the network, certain users, certain user types, certain networks, etc. to track. Pathways 202 depict based on the user interactions, the server 22 tracks the level of engagement of users at various events 33. With the data, the server 22 and algorithms predict how engaged a set of users is and if they would be close to a high state as well as their current state. A report 204, both graphical and textual, is delivered; the report is filtered by different engagement states, user types and events 33. Using the report 204, the server 22 predicts (pathway 206) how different users, user types, etc., will react to the next event(s) 33. In pathway 208, after another event 33 occurs, the event's data (e.g., user interactions, number of RSVPs, etc.) is sent back to the server 22. In pathway 210, the report 204 is adjusted based on the new data. The Pulse is now adjusted based on how engaged users are and their experience with the next series of events 33. After each event 33, the Pulse is adjusted and a new report is delivered. This can happen in real time on a set schedule or whenever the affinity group 1 wishes to create a Pulse.

Another application of this system and method is used to match affinity group members. It also arranges to have them meet. This matching takes multiple variables into account such as profession, interests, etc. that members have previously stored on the affinity group's server. Unlike the spontaneous interactions described in the previous methods of the present invention, the member selects certain characteristics of the people he/she would like to meet. He/she can also choose the time/date they would be free to meet, type of person (based on various options/variables) he/she would like to meet and/or the distance he/she is willing to travel. The member can set this as a one-time occurrence or store it/make the encounter repeat. The affinity group's server then matches members based on their selections, distance, interests, available time, etc. The server 22 also suggests a place for the group to meet as well.

The server 22 then sends a message through a message gateway 28 to a member's device 24 allowing them to accept or reject the newly formed engagement. If two or more of the participants accept, then after they meet, they can rate their experience. The server 22 stores their comments/rating and potentially uses the data when selecting a particular member's next encounter, including bringing previously matched people back together. In some variations of this system and method, connecting members together can be completely random (based only on the selections made by the user) or semi-random (where the server 22 uses previous ratings and other previous data to select potential matches in addition to the user's selections). If the server 22 tries to determine the engagement state of the user and if it reaches a certain threshold or engagement level, the server 22 may send an Ask to any of the members in attendance (before, during or after the event).

The operations of the system and method of the invention can be run on computer systems having processors for executing instructions embodying the operations of the invention. The computer systems can also have any architecture and any other processor or computer devices commonly known to those skilled in the art, including servers, memory and input and output devices. The output devices can include printers and monitors for printing and displaying information at any stage in the operations of the system and method of the invention. Windows XP, Windows Vista, Windows 7, Solaris, UNIX, Linux, or any other suitable operating system can be used by the system and method of the invention. Furthermore, the system and method of the invention can use web browsers that support the implemented display tools and technologies (e.g., AJAX, JavaScript). These browsers include recent versions of Internet Explorer, Firefox, Chrome, and other web browsers.

While the invention has been described in detail and with reference to specific examples thereof, it will be apparent to one skilled in the art that various changes and modifications can be made therein without departing from the spirit and scope thereof.

What is claimed is:

1. A system for at least one affinity group to expand its membership and engage its membership in more transactions and activities, wherein said at least one affinity group includes a central organization and a plurality of members, said system comprising:
user devices that can communicate over the Internet or telephone or data networks, each of said user devices comprising software that is customized to said at least one affinity group policies and activities, each of said user devices being associated with a respective one of said plurality of members or with a respective one of a plurality of potential members of said at least one affinity group;
at least one server, associated with said at least one affinity group, said at least one server being in communication with said user devices over said Internet, telephone or data networks, said at least one server comprising software that configures said at least one server to manage peer-to-peer interaction and central-based interaction, as well as algorithms for analyzing end user-provided data and data associated with said at least one affinity group provided thereby;
at least one message gateway positioned between said user devices and said at least one server, said at least one message gateway providing a pathway for sending a message or content between said user devices and said at least one server; and
wherein said plurality of members form peer-to-peer relationships with each other using said user devices with little or no involvement by the central organization.

2. The system of claim 1 wherein one of said user devices is a cellphone.

3. The system of claim 2 wherein said cellphone is a smartphone.

4. The system of claim 1 wherein one of said user devices is a computer.

5. The system of claim 5 wherein said computer is a tablet computer.

6. The system of claim 1 wherein said at least one server collects data related to preferences of said plurality of members via said user devices, said server using said data to form predictions about each of said plurality of members to determine when each of said plurality of members moves from an existing engagement state to a higher engagement state where said each of said plurality of members is more prone to make a purchase or a donation related to said at least one affinity group.

7. The system of claim 6 wherein said at least one server issues a request, based on said predictions, to particular ones of said plurality of members to effect said purchase or donation.

8. The system of claim 7 wherein said purchase comprises one from the group of goods, services, promotions, or content.

9. The system of claim 8 wherein said system further comprises electronic fund collecting and accounting, said electronic fund collecting and accounting permitting each of said plurality of members to securely make said purchase or said donation electronically.

10. The system of claim 6 wherein said at least one server uses said collected data to form meetup predictions that recommend the meeting of at least two members at a particular event.

11. The system of claim 10 wherein said at least one server uses said collected data to encourage spontaneous and impromptu connections between at least two members.

12. The system of claim 11 wherein said collected data comprises a distance radius specified by one of said at least two members.

13. The system of claim 10 wherein said at least one server uses said collected data to provide proposed instructions to a user for achieving predetermined goals associated with an event.

14. The system of claim 13 wherein said collected data further comprises tracking the achievement of predetermined goals by a user associated with an event.

15. The system of claim 6 wherein said collected data further comprises at least one response by a user as to how he or she reacted to different stimuli at an event.

16. The system of claim 6 wherein said collected data further comprises how a user traveled to an event.

17. The system of claim 6 wherein said collected data further comprises purchases made by the user.

18. The system of claim 6 wherein said at least one server identifies which stimuli, obstacles or promotions caused a user to deviate from, or achieving, predetermined goals associated with an event.

19. The system of claim 18 wherein said at least one server collects data from a plurality of engagements and members and generates a representation of how successful said plurality of engagements were and how engaged a plurality of users were.

20. The system of claim 19 wherein said at least one server analyzes said representation to predict how successful future events will be for said users.

21. A method for at least one affinity group expanding its membership and engaging its membership in more transactions and activities, wherein said at least one infinity group including a central organization and a plurality of members, said method comprising:
providing user devices that can communicate over the Internet or telephone or data networks, each of said user devices comprising software that is customized to said at least one affinity group policies and activities, and wherein each of said user devices is associated with a respective one of said plurality of members or with a respective one of a plurality of potential members of said at least one affinity group;
configuring at least one server with software that manages peer-to-peer interactions and central-based interactions, as well as implementing algorithms for analyzing end user-provided data and data associated with said at least one affinity group provided thereby;
coupling said at least one server with said Internet, telephone or data networks to be in communication with said user devices, said coupling involving positioning at least one message gateway between said user devices and said at least one server, said at least one message gateway providing a pathway for sending a message or content between said user devices and said at least one server; and
establishing peer-to-peer relationships among the plurality of users with little or no involvement by the central organization.

22. The method of claim 21 wherein one of said user devices is a cellphone.

23. The method of claim 21 wherein said cellphone is a smartphone.

24. The method of claim 21 wherein one of said user devices is a computer.

25. The method of claim 24 wherein said computer is a tablet computer.

26. The method of claim 1 wherein said step of configuring said at least one server comprises said at least one server collecting data related to preferences of said plurality of members via said user devices, said server using said data to form predictions about each of said plurality of members to determine when each of said plurality of members moves from an existing engagement state to a higher engagement state where said each of said plurality of members is more prone to make a purchase or a donation related to said at least one affinity group.

27. The method of claim 26 further comprising said at least one server issuing a request, based on said predictions, to particular ones of said plurality of members to effect said purchase or donation.

28. The method of claim 27 wherein said purchase comprises one from the group of goods, services, promotions, or content.

29. The method of claim 28 further comprising integrating electronic fund collecting and accounting with said at least one server, said electronic fund collecting and accounting permitting each of said plurality of members to securely make said purchase or said donation electronically.

30. The method of claim 26 further comprising said at least one server using said collected data to form meetup predictions that recommend the meeting of at least two members at a particular event.

31. The method of claim 30 wherein said step of using said collected data comprises said at least server using said collected data to encourage spontaneous and impromptu connections between at least two members.

32. The method of claim 31 wherein said collected data comprises a distance radius specified by one of said at least two members.

33. The method of claim 30 wherein said step of using said collected data comprises said at least one server using said collected data to provide proposed instructions to a user for achieving predetermined goals associated with an event.

34. The method of claim 33 wherein said step of using said collected data comprises said at least one server tracking the achievement of predetermined goals by a user associated with an event.

35. The method of claim 26 wherein said collected data further comprises at least one response by a user as to how he or she reacted to different stimuli at an event.

36. The method of claim 26 wherein said collected data further comprises how a user traveled to an event.

37. The method of claim 26 wherein said collected data further comprises purchases made by the user.

38. The method of claim 26 further comprising the step of said at least server identifying which stimuli, obstacles or promotions caused a user to deviate from, or to achieve, predetermined goals associated with an event.

39. The method of claim 38 further comprising the step of said at least one server collecting data from a plurality of engagements and members and generating a representation of how successful said plurality of engagements were and how engaged a plurality of users were.

40. The system of claim 39 further comprising the step of said at least one server analyzing said representation to predict how successful future events will be for said users.
